(19) United States
(12) Patent Application Publication
(10) Pub. No.: US 2007/0005828 A1
(43) Pub. Date: Jan. 4, 2007

(54) Interrupts support for the KCS manageability interface

(76) Inventor: Nimrod Diamant, Kfar-Saba (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,393

(22) Filed: Jun. 30, 2005

(51) Int. Cl. G06F 3/00; G06F 5/00

(52) U.S. Cl. 710/48

(57) ABSTRACT

Support for interrupts within a KCS Manageability Interface is described. In one embodiment, the invention includes writing to a KCS (Keyboard Controller-Style) data or command register, and generating an interrupt to a host of the KCS data or command register.

### FIELD

The present description relates to computing systems that can be operated from a remote console using a remote manageability interface, and in particular to allowing local applications and software agents to monitor hardware and sensors using the KCS manageability interface with reduced processor loads.

### BACKGROUND

The costs of maintaining and repairing computers can be significant. One significant factor is the time required for IT (information technology) personnel to individually maintain the operability and currency of each computer. These costs can be reduced significantly by tools that permit the IT personnel to monitor hardware and sensors remotely. For example, in a situation in which a given computer experiences errors, bugs, and overheating, it is inconvenient for IT personnel to physically travel to the particular computer in order to monitor the system's status or to try to replicate error conditions. Tools that permit the remote monitoring of hardware and software systems by delivering information across a network would eliminate the need for the IT personnel to travel, and therefore reduce costs.

IPMI (Intelligent Platform Management Interface) is an extensible standard (IPMI Second Generation v2.0 Specification promulgated by the IPMI Promoters.) that defines how users can monitor system hardware and sensors, control system components and log important system events. It is an open-standard hardware manageability interface specification. IPMI defines a specific way for management subsystems to communicate with the following other systems: Main system processing units (i.e. CPUs); other embedded management subsystems; and remote management applications (over serial lines, LANs, etc.). At the heart of IPMI management subsystems are embedded management microcontrollers such as BMCs (baseboard management controllers), EMCs (enclosure management controllers), and PMCs (peripheral management controllers). These microcontrollers sit on the system board or an add-on adapter card and communicate with hardware and software to generate event logs and status events. The IPMI standard is designed to be flexible to allow OEMs (Original Equipment Manufacturers) to provide the functionality that they deem most important.

The IPMI specification defines the KCS (keyboard controller-style) interface in detail. This interface serves the host system software and BIOS to communicate to the management controllers. The messages that travel on the interface may have control commands, data messages etc. The KCS interface is built around 4 hardware read/write registers through which controls, data and status are passed in two directions.

System controller boards (SCBs) and peripheral processor boards (PPBs) can both implement the IPMI-standard KCS (interface between the host processor and the IPMI instrumentation). They may also implement other standards—based manageability instrumentation like Intel® Active Management Technology. The KCS interface is specified solely for system management software messages. The KCS interface is designed for polled operation. The KCS interface defines a set of I/O-mapped communication registers. The registers' bit definitions and operation follow that used in the Intel® 8742 Universal Peripheral Interface microcontroller. The term “Keyboard Controller Style” indicates that the 8742 interface is used as the system keyboard controller interface on PC architecture systems. On the system side, the registers are mapped to system I/O space and may be also mapped to system memory space. The default system I/O base address for the KCS interface is CA0h (for legacy purposes) or CA2h. The low-level interface to these four registers is defined in the IPMI specification.

### BRIEF DESCRIPTION OF THE DRAWINGS

The various advantages of the embodiments of the present invention will become apparent to one skilled in the art by reading the following specification and appended claims, and by referencing the following drawings.

FIG. 1 depicts a computing system that employs a manageability platform, according to an embodiment of the present invention.

FIG. 2 depicts an example process flow for writing interrupts to a KCS interface according to an embodiment of the present invention.

### DETAILED DESCRIPTION

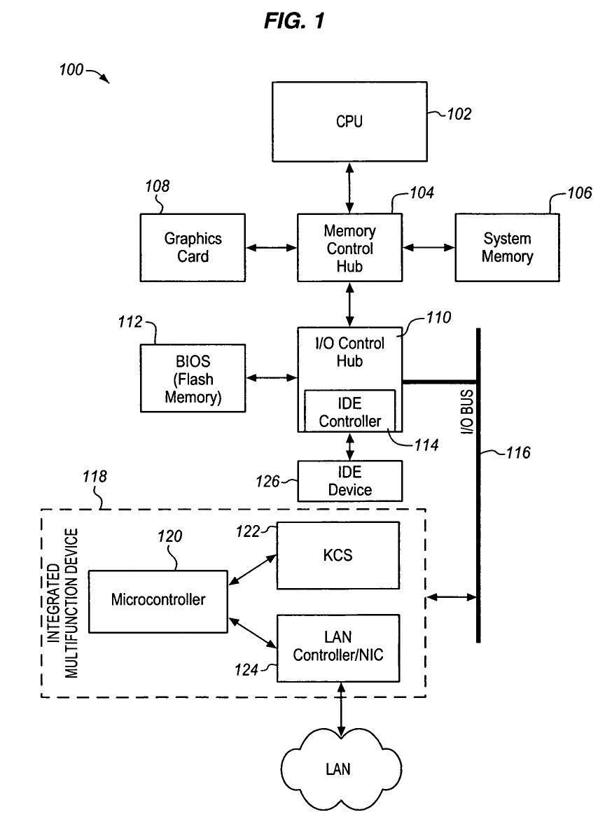

FIG. 1 depicts one example of a computing system 100 that includes a manageability platform that can implement IPMI or Intel® Active Management Technology across a network with a remote management console. As can be seen from FIG. 1, the computing system 100 includes a CPU 102, which is coupled to a memory control hub 104. The memory control hub 104 is an arrangement of circuitry that manages and controls access to the system memory 106, graphics card 108, and the input/output (I/O) control hub 110. The I/O control hub 110, in turn, manages and controls access to a flash memory device 112, which stores the BIOS.

In one embodiment, the I/O control hub manages and controls access to an IDE controller 114, which is embodied as a part of the I/O control hub 110. An IDE device 126, such as a mass storage device is coupled to the controller 114. The IDE device 126 communicates data and commands to and from the host via the controller 114. It may store the system side software such as an OS, applications, and other software. In another embodiment, the I/O control hub 110 also manages and controls access to an I/O bus 116, such as a peripheral component interconnect (PCI) bus. (In an embodiment, the I/O control hub 110 also manages and controls access to audio channels, IDE ports, and other I/O devices that are known in the art, but are not important in the context of this disclosure, and are not depicted herein).

Coupled to the I/O bus 116 is a manageability platform or an integrated multifunction device 118. As discussed in more detail below, an integrated multifunction device 118 is a single device that provides more than one function. In the particular example depicted in FIG. 1, the integrated multifunction device 118 is a single device that offers IPMI functions using KCS and a LAN controller function. Such an integrated multifunction device 118 may be presented in the marketplace as a LAN controller with built-in manageability features. Alternatively, it may be applied to devices that have a BMC separated from the LAN controller. The components of the multifunction device may also be implemented as a system board chip or a portion of a system board chip including a I/O control hub or central processing unit.

The integrated multifunction device 118 may include a microcontroller 120 coupled to KCS registers 122 (discussed below) and a LAN controller 224. The KCS registers store data and commands for use by the host CPU through the I/O bus 116 as defined in the KCS standard. The KCS interface may be made available to local manageability applications like BIOS or software agents that run in the local OS, to control, manage and update the local manageability microcontroller.

The manageability platform 118 may be used to support Intel® Active Management Technology (AMT) with any or all of its features and benefits. The KCS registers may be accessed by the microcontroller directly through AMT firmware embedded in the microcontroller. The manageability platform may be implemented as an add-on adapter card coupled to, for example, a PCI bus, or it may be integrated on the host system board or integrated into any one of the different chips shown in FIG. 1, such as the memory control hub, the I/O control hub or the CPU.

The management console (not depicted) is a computer system that communicates with the managed computing system 100. The term “managed computing system” refers to a system employing a manageability platform, such that it communicates data and commands with the remote system (i.e., management console).

BIOS or software agents that run on the local managed machine may send and receive any number of data and commands using the KCS registers. The data and commands may be any that are supported by KCS and include system status, such as power state, operating conditions, available hardware, commands, such as power commands, reset commands, etc. and event logs for BIOS, operating system, application and hardware events including bug, conflict, and error messages. The management console may interpret the data stored through the KCS interface as well as data collected by the manageability microcontroller through its other interfaces and issue commands to correct or repair the managed system.

The KCS interface is designed to support polled operation. An interrupt driven handshake, may be provided as an option but to retain compatibility, this option must not prevent the KCS driver software from the using the interface in a polled manner. The KCS software, to remain compatible must be allowed to default to polled operation. In this way, the KCS interface may operate in a polled mode until it determines the type of interrupt support.

In many implementations, the host KCS driver may be running on a very high speed processor while the manageability processor, that is the target to the KCS communications, may be relatively very slow. Persistent polling from the fast host driver may overload the manageability processor dramatically. The persistent polling may be replaced with a time driven poll (host timer resolution is typically of 10 mSec) but this may result in a slow KCS response. Defining an interrupt driven KCS interface may provide fast KCS response time without overloading the manageability processor.

TABLE 1
IPMI KCS Interface Registers

| | 7 | 6 | 5 | 4 | 3 | 2 | 1 | 0 | I/0 address |
|---|---|---|---|---|---|---|---|---|---|
| Status (ro) | S1 | S0 | OEM2 | OEM1 | C/D# | SMS_ATN | IBF | OBF | Base + 1 |

| | |
|---|---|
| Command (wo) | Base + 1 |
| Data_Out (ro) | Base + 0 |
| Data_In (wo) | Base + 0 |

Table 1 shows the conventional IPMI KCS interface registers. On the system side, the KCS registers are mapped to system I/O or memory space and consist of four byte-wide registers.
Status Register-provides flags and status bits for use in various defined operation.
Command Register-provides a port into which ‘Write Control Codes’ may be written.
Data_Out-provides a port from which data bytes may be read.

Data_In-provides a port into which data bytes and ‘Read Control Codes’ may be written.

TABLE 2
IPMI KCS Interface Status Register Bits

| BIT | Name | Description | R/W |
|---|---|---|---|
| 7 | S1 | State bit 1. Bits 7 & 6 are used to indicate the current state of the KCS | R/O |
| | | Interface. Host software may examine these bits to verify that it is in | |
| | | sync with the BMC. | |
| 6 | S0 | State bit 0. See bit 7. | R/O |
| 5 | OEM2 | OEM-reserved for BMC implementer/system integrator definition. | R/O |
| 4 | OEM1 | OEM-reserved for BMC implementer/system integrator definition. | R/O |
| 3 | C/D# | Specifies whether the last write was to the Command register or the | R/O |
| | | Data_In register (1=command, 0=data). Set by hardware. | |
| 2 | SMS_ATN | Set to 1 when the BMC has one or more messages in the Receive | R/O |
| | | Message Queue, or when a watchdog timer pre-timeout, or event | |
| | | message buffer full condition exists. OEMs may also elect to set this | |
| | | flag if one of the OEM 1, 2, or 3 flags from the Get Message Flags | |
| | | command becomes set. | |
| 1 | IBF | Automatically set to 1 when either the associated Command or Data_In | R/O |
| | | register has been written by system-side software. | |
| 0 | OBF | Set to 1 when the associated Data_Out register has been written by the | R/O |
| | | BMC. | |

In order to support interrupts, two new commands with their related protocols may be added to the KCS commands. In one embodiment, these commands are ENABLE_HOST_INT and DISABLE_HOST_INT. Additionally, a new status report bit is added to the KCS Status Register. This is the CIMV (Current Interrupt Mask Value). This bit reports to the host software whether interrupts are enabled or disabled. Finally, the OEM1 bit is moved to position 2, replacing the SMS_ATTN bit. The position 2 functionality may be shared.

TABLE 3
New KCS Interface Registers

| | 7 | 6 | 5 | 4 | 3 | 2 | 1 | 0 | I/0 address |
|---|---|---|---|---|---|---|---|---|---|
| Status (ro) | S1 | S0 | OEM2 | CIMV | C/D# | OEM1 | IBF | OBF | Base + 1 |

| | |
|---|---|
| Command (wo) | Base + 1 |
| Data_Out (ro) | Base + 0 |
| Data_In (wo) | Base + 0 |

Table 3 shows a new definition of the KCS registers. As shown in Table 3, Bits 2 and 4 are redefined as OEM 1, instead of SMS-ATN and as CIMV instead of OEM 1. Alternatively SMS-ATN may remain as originally defined.

TABLE 4
New KCS Interface Status Register Bits

| BIT | Name | Description | R/W |
|---|---|---|---|
| 7 | S1 | State bit 1. Bits 7 & 6 are used to indicate the current state of the KCS | R/O |
| | | Interface. Host Software may examine these bits to verify that it is in | |
| | | sync with the AMT FW. | |
| 6 | S0 | State bit 0. See bit 7. | R/O |
| 5 | OEM2 | OEM-reserved for AMT FW implementer/System integrator | R/O |
| | | definition. | |
| 4 | CIMV | Current Interrupt Mask Value. 0 indicates interrupt disabled in | R/O |
| | | response to ENABLE_HOST_INT, 1 indicates interrupt enabled in | |
| | | response to DISABLE_HOST_INT. | |
| 3 | C/D# | Specifies whether the last write from the system software side was to | R/O |
| | | the Command register of the Data_In register (1=command, 0=data). | |
| | | Set by hardware. | |
| 2 | SMS_ATN | OEM-reserved for AMT FW implementer/system integrator | R/O |
| | | definition. | |
| 1 | IBF | Automatically set to 1 when either the associated Command or Data_In | R/O |
| | | register has been written by system-side software. This bit is cleared | |
| | | when the Command or Data register written is read by the AMT FW. | |
| | | The host driver is not allowed to write to the Command or Data | |
| | | registers when the bit is 1. | |
| 0 | OBF | Set to 1 when the associated Data_Out register has been written by the | R/O |
| | | AMT FW. This bit is cleared when the Data register is read by the | |
| | | Host driver. The host driver is not allowed to read the Data register | |
| | | when this bit is 0. When interrupt is enabled, an interrupt to the host is | |
| | | generated when this bit is 1. | |

Table 4 refers to AMT FW (Active Management Technology Firmware). This refers to the firmware of the microcontroller on the manageability platform that implements AMT. The same functions, however, may be performed by another function or entity. Similar functions are performed in the examples of Tables 1 and 2 by a BMC. However, a BMC, as defined in the IPMI specification, is not designed to operate in the manageability context of FIG. 1. With appropriate modifications, an entity like a BMC or another entity may be used to perform these functions. While current and future features and elements of Intel® AMT may provide great benefits to many applications of the present invention, the reference to AMT FW is not meant to suggest that any such features or elements are necessary to the present invention. AMT FW is provided only as an example.

For CIMV, the power-up value is 0 (interrupt disabled). The value of this bit may change to 1 (interrupts enabled) if the host driver writes a ENABLE_HOST_INT command value to the KCS Command register. A DISABLE_HOST_INT command would return the interrupt mask to be 0 (disabled). At power-up reset, PCI reset, D3->D0 change to the KCS function, this bit will automatically get a value of 0 (and the interrupts become disabled). It is the role of the driver to disable interrupt (using the DISABLE_HOST_INT command) when it is shut down or disabled. Note that AMT FW reset should not alter the value of this bit (this means that the host driver does not have to re-enable interrupts if it detects ERROR_STATE in s0:s1 of the Status register)

The IPMI specification defines a polling handshake between the host driver and the manageability function so that at the end of a data or command transfer when the slow manageability function is ready for the next data or command, the OBF bit is set by the manageability function. In the example of Tables 3 and 4, if interrupts are enabled, whenever, the OBF bit is set, also an interrupt is generated to the host. This relieves the host from the need to poll for long times, Instead, the host is interrupt driven.

An interrupt enable and interrupt disable mechanism using OBF may also be defined. The default state of the manageability function may be as in the IPMI specification, masked off. In the default state, interrupts are not generated until the host driver specifically enables them using the ENABLE_HOST_INT command.

Two new KCS Control codes may also be added to the IPMI defined codes that the Command register accepts. The Command register may be written from the system side when the IBF flag is clear. In one embodiment, only WRITE_START, WRITE_END, ENABLE_HOST_INT, DISABLE_HOST_INT or GET_STATUS/ABORT Control Codes are written to the command register and only when the IBF flag is clear. Table 5 shows the details of the new interrupt related commands and their usage.

TABLE 5
New KCS Interface Control Codes

| | | | | Output |
|---|---|---|---|---|
| | | | Target | Data |
| CODE | Name | Description | Register | Register |
| 60h | GET_STATUS/ABORT | Request Interface Status/Abort | Command | Status |
| | | Current operation. | | Code |
| 61h | WRITE_START | Write the First byte of a Write | Command | N/A |
| | | Transfer Command. | | |
| 62h | WRITE_END | Notifies that the next write is the last | Command | N/A |
| | | byte of a Write Transfer. | | |
| 63h | ENABLE_HOST_INT | Enable KCS interrupts. This | Command | N/A |
| | | command may be issued only when | | |
| | | the KCS interface status is in | | |
| | | IDLE_STATE or in | | |
| | | ERROR_STATE. Otherwise, the | | |
| | | KCS would go into ERROR_STATE. | | |
| 64h | DISABLE_HOST_INT | Disable KCS interrupts. This | Command | N/A |
| | | command may be issued only when | | |
| | | the KCS interface status is in | | |
| | | IDLE_STATE or in | | |
| | | ERROR_STATE. Otherwise, the | | |
| | | KCS would go into ERROR STATE. | | |
| 65h-67h | reserved | Reserved. | | |
| 68h | READ | Request the next data byte. | Data_In | Next byte |
| 69h-6Fh | reserved | Reserved. | | |

Table 5 shows the use of “Control Codes” by the KCS interface. The new codes as described above are the ENABLE_HOST_INT and the DISABLE_HOST_INT.

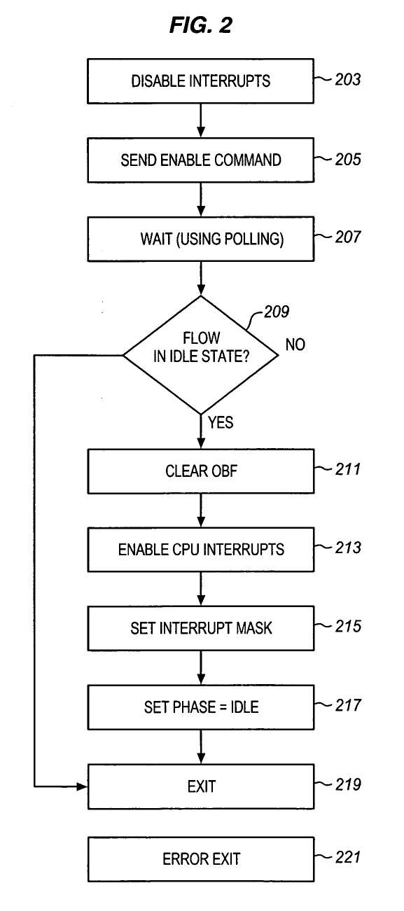

FIG. 2 shows an operational flow that may be used by the host driver (or the BIOS) to enable or to disable the KCS interrupts in accordance with one embodiment of the invention. At block 203, the KCS driver disables its CPU interrupts. At block 205 a ENABLE_HOST_INT or DISABLE_HOST_INT command is sent. This sets IBF to 1 automatically. At this point phase =wr_start. At block 207, the process waits (using polling), for either IBF=0 or IBF=1.

To ensure a clean host driver to AMT FW communication for these commands, the host driver may disable interrupts while issuing the enable/disable commands. Since the driver interrupt is disabled when the driver attempts to enable/disable interrupt, these OBFs do not generate an interrupt. Therefore, polling is required by the driver.

At block 209, the flow determines if it is in an idle state. If so, then OBF is cleared at block 211 by doing a dummy read. The driver enables its CPU interrupts at block 213. At block 215, the host verify interrupt mask is set accordingly. In other words, the CIMV bit in the Status register is read. This bit reflects the current updated interrupt mask. If ENABLE_HOST does not set the CIMV, then interrupts are not supported by the Intel® Active Management Technology FW implementation. If interrupts are not enabled then the driver may use polling. At block 217 the phase is set to idle and at block 219, the driver exits.

If the flow is not in an idle state at block 209, then the driver may enable the CPU interrupts at block 219 and the process exits.

The driver may determine the pre-existing state of interrupts by reading the Status register and checking the CIMV status bit. If this bit is set, the driver knows that interrupts are enabled. A driver that supports interrupts may issue the ENABLE_HOST_INT or DISABLE_HOST_INT commands as described in FIG. 2, to avoid unpredicted interrupts form the AMT FW, the driver may issue the ENABLE_HOST_INT or DISABLE_HOST_INT with its CPU interrupt disabled and poll for the AMT FW results. Whenever a KCS driver unloads, it may return the KCS interrupts to a disabled state.

A BIOS driver may also use interrupts for its KCS support. In one embodiment, when the BIOS hands off control to the OS, it stops its driver. The BIOS does not use the KCS while the OS driver uses it and leaves the KCS interrupts in a disabled state. In other implementations, there is more than one KCS interface to the manageability controller. In such implementations, one KCS may be dedicated for the BIOS while the other one is dedicated to the host driver.

In one embodiment, while the host KCS driver issues ENABLE_HOST_INT or DISABLE_HOST_INT commands it disables its CPU interrupts. The host driver is then required to poll on the result of the command until the AMT FW replies at the end of these commands. To shorten the time that the OS driver polls (with system interrupts disabled) on the result of these commands, the AMT FW may be expected to respond to these two commands. In other words, the AMT FW may provide a response from the FW interrupt service routine that services the FW KCS internal interface.

Embodiments of the invention may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disc storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, inventive subject matter lies in less than all features of a single disclosed embodiment. Thus, the following claims are hereby incorporated into the detailed description, with each claim standing on its own as a separate preferred embodiment.

What is claimed is:

1. A method comprising:
writing to a KCS (Keyboard Controller-Style) data or command register;
generating an interrupt to a host of the KCS data or command register

2. The method of claim 1, further comprising reading the data or command register by the host upon receipt of the interrupt.

3. The method of claim 1, further comprising enabling interrupts to the host.

4. The method of claim 3, wherein enabling interrupts comprises enabling interrupts only if a host system is in an idle state or an error state.

5. The method of claim 3, wherein enabling interrupts comprises setting a bit of the KCS registers.

6. The method of claim 5, wherein the bit of the KCS registers is a Current Interrupt Mask Value bit.

7. The method of claim 3, wherein enabling interrupts switches a KCS interface of the KCS registers between polling operation and interrupt operation.

8. The method of claim 1, further comprising disabling interrupts to the host upon system reset.

9. The method of claim 1, wherein generating an interrupt comprises generating an interrupt in response to an OBF bit of the KCS registers being set.

10. The method of claim 1, further comprising disabling interrupts upon shutdown of a host system.

11. A machine-readable medium carrying data, that when operated on by the machine, cause the machine to perform operations comprising:
writing to a KCS (Keyboard Controller-Style) data or command register;
generating an interrupt to a host of the KCS data or command register

12. The medium of claim 11, the instructions further comprising reading the data or command register by the host upon receipt of the interrupt.

13. The medium of claim 11, the instructions further comprising enabling interrupts to the host.

14. The medium of claim 13, wherein enabling interrupts comprises enabling interrupts only if a host system is in an idle state or an error state.

15. The medium of claim 13, wherein enabling interrupts switches a KCS interface of the KCS registers between polling operation and interrupt operation.

16. The medium of claim 11, wherein the instructions further comprise disabling interrupts to the host upon system reset.

17. The medium of claim 11, wherein the instructions further comprise disabling interrupts upon shutdown of a host system.

18. An apparatus comprising:
a plurality of KCS (Keyboard Controller-Style) data and command registers;
a host system having system software to write to the data and command registers; and
firmware to generate an interrupt to the host system when the data and command registers are written to.

19. The apparatus of claim 18, further comprising a BIOS (Basis Input Output System) to enable and disable interrupts.

20. The apparatus of claim 18, further comprising a network controller to send KCS data to a remote management console.
